(19) United States
(12) Patent Application Publication
(10) Pub. No.: US 2006/0120549 A1
(43) Pub. Date: Jun. 8, 2006

(54) Sound generating apparatus, a mobile electric device and a system for generating sound

(76) Inventor: Gunther Burghardt, Bochum (DE)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/530,952

(22) PCT Filed: Oct. 10, 2002
(86) PCT No.: PCT/IB02/04162

§ 371 Date: Dec. 15, 2005

(51) Int. Cl. H04R 1/02

(52) U.S. Cl. 381/351

(57) ABSTRACT

A sound generating apparatus comprises a first cavity 110, a second cavity 120 and an electromechanical transducer 100 that emits sound waves into the first cavity and the second cavity. A third cavity 130 is connected to both the first and second cavities via a first passage 115 and a second passage 125. Sound waves of the first cavity 110 pass to the third cavity 130, via the first cavity and the second passage serves as a passage for sound waves to the third cavity 130. Passed through sound waves are mixed in the third cavity 130 and are allowed for passing through one or several outlets 150 for emitting sound into an exterior of the apparatus. A mobile electric device is provided having integrated the above described sound generating apparatus and a system for generating sound of improved quality being based on components integrated in the sound generating apparatus.

The present invention relates to a sound generating apparatus providing an enhanced frequency performance, bandwidth and sound pressure level, and particularly the present invention relates to a sound generating apparatus having such a small size to be implementable in portable electric devices.

Transducers and loudspeaker are used, respectively, to reproduce voice, speech, sound, music and the like supplied with a certain type of electrical signals. The electrical signals cause an operation of the transducers and loudspeakers, respectively, resulting in exciting sound waves emerging from the transducers and loudspeakers. The emerging excited sound waves shall correspond as close as possible to the original voice, speech, sound, music and the like to be reproduced. Good quality of reproducing is quite hard to approach, since the reproducing quality of transducers and loudspeaker depend on several device inherent characteristics which have to be optimized simultaneously.

The human organ of hearing, i.e. simplified denoted as both ears of a human being, is able to receive and recognize sound waves in an audible frequency range having a minimal lower limit of approximately 20 Hz and having a maximal upper limit of approximately 20 kHz (approximately 18 kHz for adults). The bandwidth of transducers should cover as well as possible the aforementioned perceptible frequency range. Additionally, the acoustic power of transducers, i.e. the sound pressure level, should be as constant as possible over the complete perceptible frequency range such that sound signal reproduction is as close as possible to the original sound signal.

These requirements have been reached in traditional loudspeaker systems including several transducers each for reproducing partial individual frequency sections being adapted to each other such that the complete audible frequency range is covered. The relative large seize of the several transducers as well as a large sized enclosure housing the several transducers contribute to the high sound level capability being substantially constant over the complete audible frequency range. Conventionally, the spacious interior of such a loudspeaker system enclosure is used as resonance room resulting in a resonance amplification within certain acoustic windows (i.e. certain frequency sections).

In case of a single transducer and especially a single transducer having a relative small size the aforementioned requirements are still problematic to overcome. Small sized transducers and sound generating devices being based on small sized transducers shall denote devices to be integrated in portable devices allowing only small dimensioned components. Consequently, these sound generating devices have also to cover as broad as possible the audible frequency range (i.e. the bandwidth) with a suitable sound pressure level over the audible frequency range although the exciting surface for sound waves is relative small and resonance amplification which can compensate deficiencies in the sound pressure level at certain frequency sections is limited due to limited available resonance space and limited overall enclosure.

The implementing of multi-media features in mobile phone such as polyphonic alarm signals involving the reproducing of multi-channeled sound, music reproduction and overall improved sound and voice reproduction for example in conjunction with free-hand operation of the mobile phones is gaining a higher status for the purchasers of the mobile phones. But especially the sound generating apparatus implemented in today's mobile phones lack of the desired reproduction quality.

Furthermore, the harmonization of these two main concerns, i.e. the reproducing of ringing and/or alert tone signals and the play-back of music, is also difficult to achieve because the ringing and/or alert tone signals are preferably within a frequency range to which the human organ of hearing is most sensitive, that is, a frequency range between approximately 2 kHz to 7 kHz, and more particularly a frequency range of approximately 2 kHz to 3 kHz is of importance for generating clearly perceptible ringing and/or alert tone signals. Acoustic resonances within this most sensitive frequency range of human hearing allow for meeting this requirements. The play-back of music requires a more flatten and a more natural timbre frequency response of the sound generating apparatus, respectively.

The object of the invention is to improve a sound reproducing capability and the characteristics of a sound generating apparatus which is especially suitable for being integrated in a mobile electrical device. The object of the invention is achieved with a sound generating apparatus having improved reproducing properties and a mobile electrical device having integrated sound generating apparatus with improved reproducing properties which are disclosed in the independent claims. Additional embodiments of the invention are disclosed in the dependent claims.

According to an embodiment of the invention, a sound generating apparatus is provided. The apparatus comprises a first cavity, a second cavity and an electromechanical transducer. The electromechanical transducer is employed to excite sound waves in the first cavity and in the second cavity. A further third cavity is additional comprised in the apparatus. This third cavity is connected to both the first cavity and the second cavity via a first passage and a second passage both being of individual pre-defined shape and dimensions. The first passage serves as a sound wave passage allowing sound waves of the first cavity to pass to the third cavity. The second passage serves as a sound wave passage allowing sound waves of the second cavity to pass to the third cavity. The first passage as well as the second passage are both the only passages allowing sound wave emission from the respective first and second cavity, respectively. These passed through sound waves are mixed (superimposed) in the third cavity and are allowed for passing through one or several outlets for emitting sound into an exterior of the apparatus. The resulting emitted sound waves out of the third cavities sound outlets to the exterior of the apparatus depend on the acoustic properties of all interacting cooperative acoustic components, i.e. at least the acoustic properties of the first cavity in conjunction with the first passage, the second cavity in conjunction with the second passage and the third cavity in conjunction with the outlets.

According to an embodiment of the invention, the electromechanical transducer has a main direction for emitting sound and a supplementary direction for emitting sound or for exciting sound waves, respectively. The electromechanical transducer excites sound waves of a high sound pressure level into the main direction. The sound waves emitted along this main direction are radiated into the first cavity and sound waves emitted along the supplementary direction are radiated into the second cavity. The supplementary direction may be the opposite direction in relationship to the main direction.

According to an embodiment of the invention, the first cavity has a first volume and the second cavity has an essential bigger second volume. The first volume of the first cavity is adapted and designed such that this volume acts as a resonator for mid or high sound frequencies, whereas the second volume of the second cavity is adapted and designed such that this volume acts as a resonator for low sound frequencies

According to an embodiment of the invention, the first cavity and the third cavity have substantially approximately the same volume.

According to an embodiment of the invention, the first cavity and the second cavity are arranged adjacent to each other. The electromechanical transducer is interposed between the adjacent first cavity and the second cavity to separate spatially one from the other.

According to an embodiment of the invention, the electromechanical transducer is a conventional electromagnetic loudspeaker.

According to an embodiment of the invention, the apparatus is applicable in and suitable for being implemented in a portable electric device.

According to an embodiment of the invention, a mobile electric device having integrated a sound generating apparatus is provided. The apparatus comprises a first cavity, a second cavity and an electromechanical transducer. The electromechanical transducer is employed to emit sound waves into the first cavity and the second cavity. A further third cavity is additional comprised in the apparatus. This third cavity is connected to both the first cavity and the third cavity via a first passage and a second passage both being of individual pre-defined shape and dimensions. The first passage serves as a sound waves passage allowing sound waves of the first cavity for passing to the third cavity. The second passage serves as a sound waves passage allowing sound waves of the second cavity for passing to the third cavity. These passed through sound waves are mixed in the third cavity and are allowed for passing through one or several outlets for emitting sound into an exterior of the apparatus.

Further embodiments of the mobile electric device having an integrated sound generating apparatus can be obtained from the aforementioned description of embodiments of the sound generating apparatus according to the invention.

According to an embodiment of the invention, a system for generating sound is provided. The system comprises a first cavity, a second cavity and an electromechanical transducer. The electromechanical transducer is employed to emit sound waves into the first cavity and the second cavity. A further third cavity is additional comprises in the apparatus. This third cavity is connected to both the first cavity and the third cavity via a first passage and a second passage both being of individual predefined shape and dimensions. The first passage serves as a sound waves passage allowing sound waves of the first cavity for passing to the third cavity. The second passage serves as a sound waves passage allowing sound waves of the second cavity for passing to the third cavity. These passed through sound waves are mixed in the third cavity and are allowed for passing through one or several outlets for emitting sound into an exterior of the system.

Further embodiments of the system for generating sound can be obtained and derived from the aforementioned description of embodiments of the sound generating apparatus according to the invention.

It invention will be described in greater detail by means of embodiments with reference to the accompanying drawings, in which

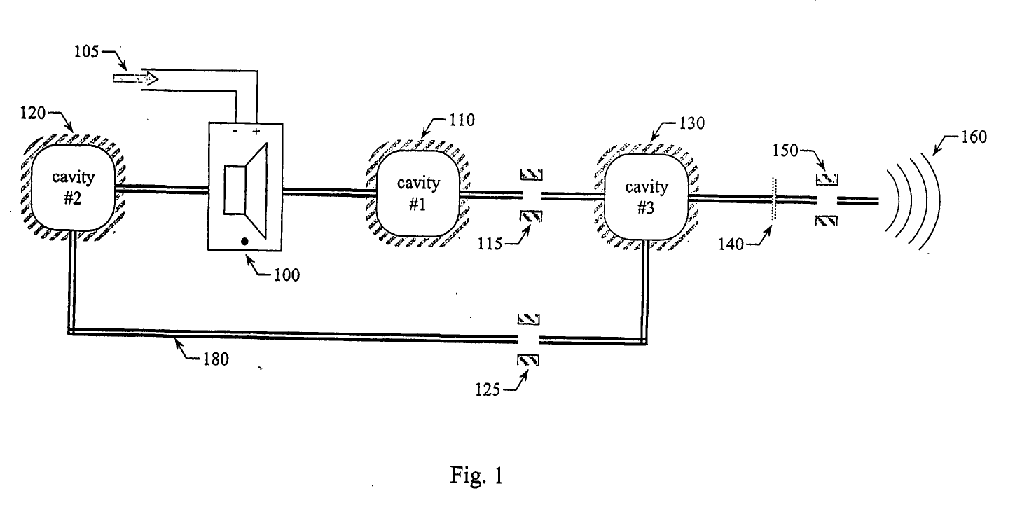

FIG. 1 shows an electro-acoustic model illustrating elements for forming a sound generating apparatus according to an embodiment of the invention;

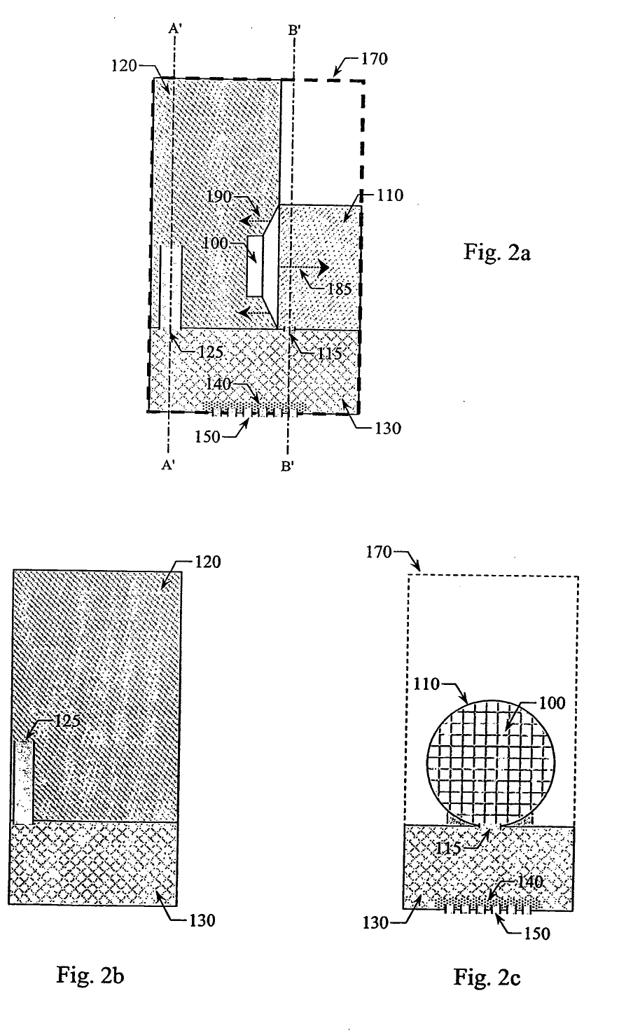

FIG. 2a shows a first schematic cross-sectional view of a sound generating apparatus according to an embodiment of the invention;

FIG. 2b shows a second schematic cross-sectional view of a sound generating apparatus according to an embodiment of the invention;

FIG. 2c shows a third schematic cross-sectional view of a sound generating apparatus according to an embodiment of the invention;

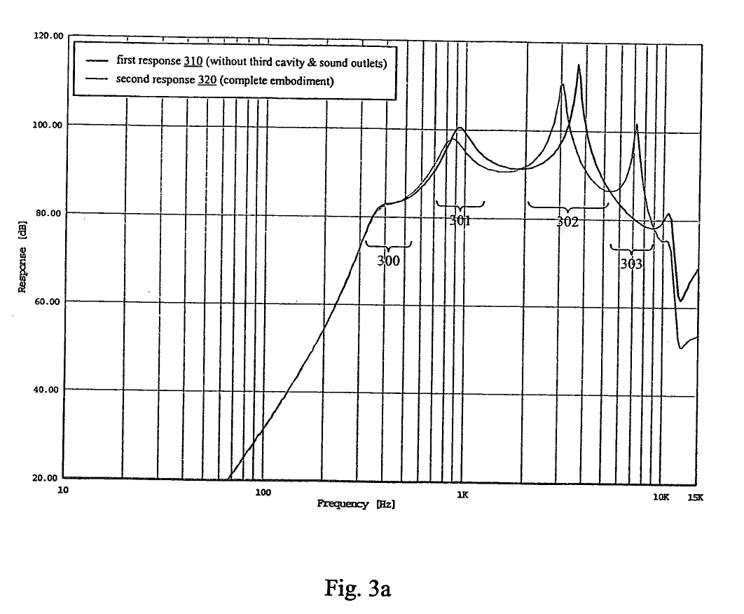

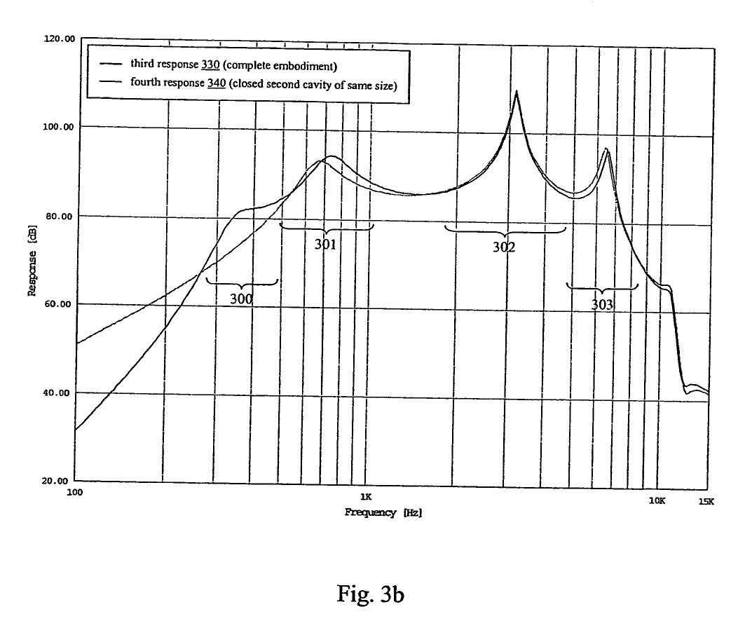

FIG. 3a shows a frequency response curve plot comprising two frequency response curves being based on an embodiment of a sound generating device according the invention and a modification of this embodiment;

FIG. 3b shows a frequency response curve plot comprising two frequency response curves being based on an further embodiment of a sound generating device according the invention and a modification of this embodiment; and

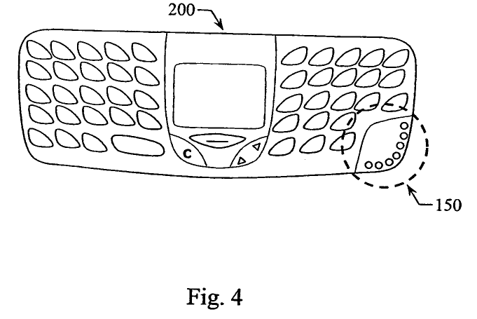

FIG. 4 shows a mobile electronic device having implemented a sound generating device according to an embodiment of the invention.

Same or equal parts, features and/or operations shown in the figures will be referred to using the same reference numerals.

An introduction to the inventive concept of a sound generating device according to the invention will be given in conjunction with an electro-acoustic model comprising elements required for the sound generating device and depicting the acoustic interactions with each other in an illustrative way.

FIG. 1 shows an electro-acoustic model illustrating elements for forming a sound generating device according to an embodiment of the invention. The illustrated model comprises a first cavity 110, a transducer 100 and a second cavity 120. The transducer 110 directly excites acoustic waves within the first cavity 110 and the second cavity 120. The excited acoustic waves within the first cavity 110 and the second cavity 120 are coupled into a third cavity 130 via a first passage 115 and a second passage 125 allowing for mixing these acoustic waves , thereby generating superimposed acoustic waves to be radiated into the exterior via outlets 150.The acoustic coupling of the depicted elements is illustrated by acoustic coupling paths depicted as double lines as for example the acoustic coupling path 180 coupling acoustically the second cavity 120 to the second passage 125 and finally to the third cavity 130. An acoustic coupling may be understood as an coupling and decoupling of energy, herein acoustic energy, respectively.

Conventionally, a transducer is an electromechanical transducer converting (transforming) an electric signal and electric energy into a mechanical excitation which again excites sound waves. In FIG. 1, the supplying electric signal of the transducers is indicated by reference numeral 105. Conventionally, such an electromechanical transducer is based on an electromagnetic interacting system being designed of an electrical coil and a magnet wherein one of the both components is mounted in a fixed way and the other one is moved about a neutral position for exciting a vibratable surface allowing for emitting sound waves. Further excitation methods may be alternatively used having in common emitting and exciting of sound waves. For example, transducers being based on electro-static repulsion are also available.

Further conventionally, transducers have a main excitation direction 185 (main sound emitting direction 185), i.e. a dedicated direction in which sound waves are mainly emitted and in which the emitted sound waves have the highest average sound pressure level. The surface of a transducer from which the main emitting direction 185 of the transducer extends will be denoted in the following as the front surface of the transducer, whereas the opposite direction to the main emitting direction 185 will be denoted in the following as a supplementary direction 190 being correspondingly associated with a back surface of the transducer.

The first cavity 110 and/or the second cavity 120 serve as acoustic resonators having different resonance characteristics for amplfying the sound pressure level in certain different frequency sections. Resonance amplifying is especially employed in frequency sections in which sound generating (exciting) devices, i.e. transducers, are inefficient, i.e. generate low frequency signals with low sound pressure level, or when it is desired to rise the sound pressure level in one or frequency sections. Especially, small transducers, i.e. transducers employing a small interacting surface for exciting acoustic waves, i.e. relative to the wave length of the excited acoustic waves, offer a less yield especially in low frequency sections. Particularly, the second cavity 120 serves as an acoustic resonator for amplifying low acoustic frequencies in conjunction with the second passage 125. The acoustic properties of both the second cavity 120 and the second passage 125 contribute to the resulting resonance amplification.

The acoustic properties of the cooperating second cavity 120 and the second passage 125 resulting in the acoustic behavior of this arrangement are determined among other things by a physical volume/dimensions of the second cavity 120 and a design or construction of the second passage 125, respectively, without making demands on completeness. Further, as aforementioned the transducer 100 of the sound generating device according to an embodiment of the invention excites directly both the first cavity 110 and the second cavity 120, wherein the second cavity 120 is designed in such a way that acoustic short cutting to the second cavity 120 of that part (surface) of the transducer 100 emitting sound wave radiation into the first cavity 110 is prevented which may otherwise result in a low emitting efficiency. The design of the second cavity 120 is constructed in such a way that the stiffness of the air therein is reduced to enhance the low frequency efficiency and to form a resonator allowing for resonance amplifying with a corresponding suitable frequency range. These conditions can be attained by designing a second cavity 120 having a significant larger volume than the volume of the first cavity 110. Particularly, the volume of the second cavity 120 is larger by one or more magnitudes in comparison to the volume of the first cavity 110.

As aforementioned, the resonance amplification is a cooperative effect depending on the acoustic properties of both the second cavity 120 and the second passage 125 and their interaction. Besides this resonance amplification further mixing effects occurring in the third cavity 130 have to be taken into consideration at designing of the second passage 125. The dimensioning of this second passage 125 has an impact on the characteristics of the sound generating device according to an embodiment of the invention. The length dimensioning of this passage also provides the possibility to control a supplementary phase shift of acoustic waves coming from the second cavity 120 in relation to acoustic waves coming from first cavity 110 both being excited directly by the transducer 100 and being mixed (superimposed) in the third cavity 130. This has the physical effect that acoustic waves with low frequencies from the first cavity 110 and second cavity 120 are added in the mix cavity. If the designing of the second passage 125 is unsuitable, e.g. the length of the second passage 125 is too short, this would result in an unsuitable rise of the lower cut-off frequency. The suitable length dimensioning depends among other things on the volume of the second cavity 120 and the transducer properties.

Moreover, the design of the third cavity 130 and the sound outlets 150 to the outer exterior has also to take consideration of the decoupling of acoustic energy, that is, the energy loss due to acoustic waves emission through the second passage 125 from the second cavity 125 to the third cavity 130 and outlets 150. The decoupling of acoustic energy depends on the layout of the second passage 125 and the acoustic properties of the third cavity 130 emitting finally acoustic waves into the exterior. A decoupling of acoustic energy being too strong, i.e. too high losses due to a small flow-through area of the sound outlets 150 may destroy resonance characteristics of the interacting second cavity 120 and second passage 125 and thus also the aspired resonance amplification.

The excitation of acoustic waves with frequencies being within the low frequency section by small transducers, i.e. of such a kind employed herein, is less efficient (considerably bad) such that the second passage 125 employed for decoupling of acoustic waves therefrom has to be designed carefully ensuring the preventing of the resonance characteristics of the second cavity 120 and the second passage 125. The second passage 125 may be realized as an extended tube-like passage having a pre-defined and adapted cross-sectional area (e.g. diameter) as well as elongated extension (e.g. length).

The first cavity 110 serves as an acoustic resonator for amplifying mid and/or high acoustic frequencies, particularly above the low acoustic frequency section relating to the second cavity 120. Particularly, the first cavity 110 serves as an acoustic resonator for acoustic amplifying in conjunction with the first passage 1 15. The acoustic properties of both the first cavity 110 and the first passage 115 contribute to the resulting resonance amplification. Analogously, the acoustic properties of the cooperating first cavity 110 and the first passage 115 resulting in the acoustic behavior of this arrangement are determined among other things by a physical volume/dimensions of the first cavity 110 and a design or construction of the first passage 115, respectively, without making demands on completeness. As aforementioned, the resonance amplification is a cooperative effect depending on the acoustic properties of both the first cavity 110 and the first passage 115 and their interaction, analogously to the description in context with the second cavity 120 and the second passage 125.

The excitation of acoustic waves with frequencies being within the mid and/or high frequency section by small transducers, i.e. of such a kind employed herein, is efficient (considerably good) such that the design of first passage 115 is not subjected to the strict requirements as described with reference to the second passage 125. Therefore, in case the third cavity 130 is arranged adjacent to the first passage 115 the second passage 125 may be realized as an opening in a wall being part of the first cavity 110 and the third cavity 130, respectively, wherein the opening has a pre-defined shape and dimensions (e.g. a slit of certain height and width).

The third cavity 130 is in connection to the first cavity 110 and the second cavity 130. The first passage 115 allows for passing through acoustic waves from the first cavity 110, whereas a second passage 125 allows for passing through acoustic waves from the second cavity 120. The third cavity 130 serves to mix the coupled in acoustic waves from the first cavity 110 as well as from the second cavity 120.

Furthermore, the third cavity 130 serves itself also as an acoustic resonator for acoustic amplifying in mid and/or high frequency sections. Correspondingly, the third cavity 130 serves as an acoustic amplifier in conjunction with one or more outlets 150 allowing for emitting acoustic waves to the exterior of the sound generating device. The acoustic properties of both the first cavity 110 and the first passage 115 as well as acoustic properties of both the second cavity 120 and the second passage 125 contribute to the resulting resonance amplification. Moreover, the acoustic properties of both the third cavity 130 and the outlets 150 have back effects on the acoustic properties of the first cavity 110 in conjunction with the first passage 1 15 and the second cavity 120 in conjunction with the second passage 125. These back effects are of different magnitude or may effect only one of the first cavity 110 in conjunction with the first passage 1 15 and the second cavity 120 in conjunction with the second passage 125.

The mixed sound waves in the third cavity 130 originating from the first cavity 110 and the second cavity 120 represents the final complete sound signal to be emitted into the exterior for being heard by a person. The mixture has the desired bandwidth, sound pressure level and frequency performance. The bandwidth of a sound generating apparatus is to be understood as this frequency range within that the frequency dependent sound pressure level is above a certain predefines level. A sound reproduction of good quality requires a suitable width of the signal bandwidth, i.e. a suitable lower frequency limit and a upper frequency limit.

These sound characteristics (bandwidth, sound pressure level and frequency performance) result from the individual sound characteristics of the first cavity 110, the second cavity 120 and the third cavity 130 under consideration of the transfer properties of the first passage 115 connecting the first cavity 110 and the third cavity 130 and the transfer properties of the second passage 125 connecting the first cavity 110 and the third cavity 130. That is, the acoustic components presented above form an overall arrangement of components being acoustically active such that the acoustics properties have to be considered in an inter-cooperating manner.

The third cavity 130 has one or more outlets 150 for decoupling or radiating the resulting mixed sound waves into the exterior. Correspondingly to the adapted design of the first passage 115 and the second passage 125 interconnecting the cavities an adapting of design and arrangement of the one or more outlets 150 guarantees that the resulted sound characteristics in the third cavity 130 are also valid for the sound 160 radiated into the exterior.

According to an embodiment of the invention, a dust shielding 140, for example embodied as a dust net having a predefined fabric structure particularly adapted to the acoustic properties of the sound generating device, separates the interior of the third cavity 130 from the exterior environment. The dust shielding 140 may prevent dust from penetrating into the third cavity since dust and other dirt particles may have influence on the sound characteristics of the cavities and interfere the above described frequency matching of the cavities. The shielding 140 can be arranged in the third cavity such that the outlets are covered by the shielding wherein the shielding may be close to the outlets or may be spaced with a predefined distance from the outlets. The shielding 140 may be made of plastic foam, fabric and the like.

As the dimension of the sound outlets 150 has an impact on the acoustical behaviour of the overall sound generating device and the arrangement of the several acoustic components, respectively, it is preferred to have the dust shielding 140 in a predefined distance from the sound outlets 150, because in this case the dust shielding 140 embodied as a dust net does not have an impact on the throughput area of the outlets 150 in case that the dust net is dimensioned large enough. The dust shielding 140 in combination with the sound outlets 150 have to ensure that the overall acoustic energy losses due to radiation into the exterior is not as extensive so as to interfere with the resonances of the several cavities in conjunction with their passages which may result in a inefficient resonance amplification.

It shall be noted that in order to obtain improved resulting sound characteristics in case of employing a small sized transducer 100 the low frequency amplification achieved by the low frequency resonance adaptation of the second cavity 120 and/or the second passage between second and third cavities 120 and 130. The generation of mid and high frequencies can be achieved by small sized transducers 100 in a suitable and acceptable way also without requiring resonance adaptation of the first cavity. 110 Nevertheless, the provided arrangement comprising a first, a second and a third cavities 110, 120 and 130 is necessary in order to mix sound of low frequencies from the second cavity 120 to the sound of mid and high frequencies from the first cavity 110 without interfering the sound characteristics in the first cavity 110 as also in the second cavity 120.

FIG. 2a shows a first schematic cross-sectional view of a sound generating apparatus according to an embodiment of the invention. More precisely, FIG. 2a shows a first schematic illustration with reference to a cross-sectional plane perpendicular to the main emitting direction 185 of the transducer.

As described with respect to the schematic model referred in FIG. 1 the embodiment shown in FIG. 2a depicts a first cavity 110, a second cavity 120, a third cavity 130 and a transducer 100. The cavities 110, 120 and 130 are arranged adjacent to each other in a total volume optimizing way. The cavities 110, 120 and 130 and the transducer 100 are jointly housed in a common enclosure such as an enclosure indicated by the dashed enclosure contour 170. The first cavity 110 and second cavity 120 are spatially separated by the transducer 100. The transducer 100 emits sound waves along its main exciting direction 185 directly into the first cavity 110 (i.e. also denoted as front sound emission) whereas it emits sound waves along its supplementary exciting direction 190 directly into the second cavity 120 (i.e. also denoted as back sound emission). For example, in case the transducer 100 is a loudspeaker having a vibrating membrane for exciting sound waves this membrane separates both the first cavity 110 and the second cavity 120 such that each cavity 110 and 120 have its own resonance characteristics.

The embodied back sound emission is used to excite sound waves in the second cavity 120 having low resonance frequencies, operating as a bass amplifying cavity. The damping of low frequencies is smaller than the damping of higher frequencies such that the back sound emission for exciting the second cavity is suitable and efficient. The first cavity 110 has mid or high resonance frequencies, operating as a mid or high pitch amplifying cavity. Since the damping of the corresponding frequencies is higher a the direct exciting of the first cavity 110 guarantees proper amplifying operation.

The first and second passages 115 and 125 connect the first and second cavities to the third cavity 130, respectively. The third cavity 130 is arranged adjacent to both the first and the second cavities 115 and 125. The first passage 115 is embodied as a slit of small height. The slit is designed as an opening in the common wall separating the first cavity 110 from the third cavity 130. The second passage 125 is embodied as a tube-like passage having an elongated length wherein the tube-like passage is arranged in the second cavity 120 for the most part.

A dust shielding 140 is arranged in the third cavity 130 and placed directly in front of the several outlets 150 connecting the third cavity 130 to the exterior in order to allow the issue of sound.

The following FIG. 2b and 2c show a second cross-sectional view and a third cross-sectional view of a sound generating apparatus according to an embodiment of the invention.

More precisely, FIG. 2b and FIG. 2c show schematic illustrations with reference to two different cross-sectional planes each being parallel to the main emitting direction 185 of the transducer and being perpendicular to the cross-sectional plane shown in FIG. 2a.

In FIG. 2b the second cavity 120, the third cavity 130 and the second passage 125 connecting the second and third cavities 120 and 130 are depicted. This depiction may represent a cross-sectional view obtained from a cross-section through the in FIG. 2a embodied sound generating apparatus along the line A′-A′. In combination with the depiction shown in FIG. 2a the second passage 125 may have a rectangular or annular shaped cross-sectional area.

In FIG. 2c, the first cavity 110, the third cavity 130, the first passage 115 as well as the dust shielding 140 and the outlets 150 are depicted. This depiction may represent a cross-sectional view obtained from a cross-section through the in FIG. 2a embodied sound generating apparatus along the line B′-B′. In combination with the depiction shown in FIG. 2a the first passage 115 may have a rectangular or slit shaped cross-sectional area. The width of the first passage 115 is larger than the depicted height.

In case of a three dimensional depiction of FIG. 2c the illustrated view may disclose the wave exciting surface of the transducer 100 which is indicated by squared filling of the illustration of the first cavity 110. In case that the transducer 100 is a loudspeaker the exciting surface is its vibratable membrane excited to vibrated by the means of an electromagnetic excitation system. According to an embodiment of the invention, the first cavity 110 has a volume in a range of approximately 150 mm³ to 250 mm³ particularly a value of approximately 180 mm³), the second cavity 120 has a volume in a range of approximately 2 cm³ to 3 cm³ (particularly a value of approximately 2.6 cm³) and the third cavity 130 has a volume in a range of approximately 150 mm³ to 250 mm³ (particularly a value of approximately 200 mm³). The one or more outlets 150 for radiating mixed sound into the exterior may be embodied as six holes each of having a diameter of approximately 2 mm. The dust shielding 140 may be embodied as dust net being shaped as an adhesive ring of 0.5 mm thickness being mounted in front of the outlets 150 within the third cavity 130 and spaced apart from the outlets 150 about a certain distance thereof.

The presented volumes of the cavities 110, 120 and 130 depend on the transducer 100 employed in the sound generating device according to an embodiment of the invention and depend on the dimensioning of the passages 115 and 125 or vice versa, i.e. the dimensioning of the passages 115 and 125 have to be adapted to the volume dimensions and vice versa.

As aforementioned, the acoustic properties of the system are based on cooperative effects of the cavities 110, 120 and 130 and their passages 115, 125 and the one or more outlets 150, respectively. The following FIG. 3a and FIG. 3b depict each two frequency response curves one being based on an embodiment of the sound generating device according to the invention and the other being based one a modified embodiment of the sound generating device. The frequency response curves allow to demonstrate and discuss more detailed the cooperative interacting of the cavities and/or passages of the sound generating device according the a respective embodiment of the invention.

FIG. 3a shows a frequency response curve plot comprising two frequency response curves being based on an embodiment of a sound generating device according the invention and a modification of this embodiment. The first frequency response curve 310 being shaded black represents a frequency response curve of a sound generating device being arranged in accordance with an embodiment of the invention but without having a third cavity 130 and sound outlets 150. The second frequency response curve 320 being shaded gray represents a frequency response curve of a sound generating device according to the above presented embodiment of the invention but having this third cavity 130 and these sound outlets 150.

The frequency-response diagram including both the first frequency response curve 310 and the second frequency response curve 320 has a logarithmic frequency abscissa and a linear acoustic signal power ordinate. A number of four frequency ranges 300, 301, 302 and 303 out of the total depicted frequency range (10 Hz to 15 kHz) are emphasized. The curve plot within each of the four frequency ranges 300, 301, 302 and 303 of each frequency response curve is associated with one or more certain components of the sound generating device.

The first frequency range 300 covers a point of inflexion in both the first frequency response curve 310 and the second frequency response curve 320. This point of inflexion is caused by a resonance peak being within a rising frequency response curve section. This resonance peak is caused by the acoustic properties of the second cavity 120 in conjunction with the second passage 125, i.e. acoustic properties of the second cavity 120 being primarily defined by its volume in conjunction with the second passage 125 embodied as a vent having a certain predefined cross-sectional area and a predefined certain length depending on the volume (or vice versa, respectively). The resonance peak is in the range of approximately 400 Hz and acts as a low frequency amplification of acoustic signals. Low frequency acoustic signals are excited in both the second cavity 120 and the first cavity 110, whereas the second cavity 120 in conjunction with the vent is designed to act as a low frequency acoustic amplifier. The predefined certain length of the vent ensures that the superimposing of that part of low frequencies emitted by the first cavity 110 and the acoustic amplified low frequency emission of the second cavity 120 is constructive, i.e. the predefined certain length guarantees a phase adaptation of acoustic waves of the same frequency emitted by the first and the second cavity 110 and 120.

The second frequency range 301 covers a further resonance peak resulting from the acoustic properties of the transducer 100 used in this embodiment of the sound generating device. This resonance peak represents the main acoustic resonance peak of the transducer 100. In case of the first resonance curve 310 the transducer main resonance peak is in the range of approximately 950 Hz whereas in case of the second resonance curve 320 the transducer main resonance peak is in the range of approximately 850 Hz. The existence of the third cavity 130 causes that frequencies of the transducer main resonance peak are shifted to lower frequencies.

The third frequency range 302 covers a further resonance peak resulting from the acoustic properties of the first cavity 110 in conjunction with the acoustic properties of the first passage 115 or the slit having a predefined cross-sectional area, respectively. In case of the first resonance curve 310 the resonance peak is in the range of approximately 3 kHz, whereas in case of the second resonance curve 320 the resonance peak is in the range of approximately 3.5 kHz. The existence of the third cavity 130 causes that frequencies of the first cavity resonance peak are shifted to lower frequencies analogously to the transducer main resonance peak.

The fourth frequency range 303 covers a further resonance peak resulting from the acoustic properties of the third cavity 130 in conjunction with the acoustic properties of the sound outlets 150 providing a predefined total cross-sectional area. In case of the first resonance curve 310 no corresponding resonance peak occurs in the plot since the embodiment of the sound generating device in accordance to which the measurement of the frequency response curve 310 has been taken includes no corresponding third cavity 130 and no corresponding outlets 150. In case of the second resonance curve 320 the resonance peak is in the range of approximately 6.7 kHz.

Herein, the interacting of the acoustic cooperative components, i.e. the cavities 110, 120 and 130 as well as the influences of the connecting passages 115, 125 and 150, can be seen clearly. A following further frequency response curve plot may further enlighten the relationships thereof.

FIG. 3b shows a frequency response curve plot comprising two frequency response curves being based on a further embodiment of a sound generating device according the invention and a modification of this embodiment. The third frequency response curve 330 being shaded black represents a frequency response curve of a sound generating device being arranged in accordance with an embodiment of the invention. The fourth frequency response curve 340 being shaded gray represents a frequency response curve of a sound generating device according to the above presented embodiment of the invention but with a closed second cavity 120, i.e. without a second passage 125 or vent allowing acoustic waves to pass through to the third cavity 130.

The frequency-response diagram including both the third frequency response curve 330 and the fourth frequency response curve 340 has a logarithmic frequency abscissa and a linear acoustic signal power ordinate. A number of four frequency ranges 300, 301, 302 and 303 out of the total depicted frequency range (100 Hz to 15 kHz) are emphasized. The curve plot within each of the four frequency ranges 300, 301, 302 and 303 of each frequency response curve is associated with one or more certain components of the sound generating device.

The first frequency range 300 covers a point of inflexion in the third frequency response curve 330 being not present in the fourth frequency response curve 340. As aforementioned this point of inflexion is caused by an acoustic resonance amplification peak being substantially in the same frequency range and analogously resulting from the acoustic properties of the second cavity 120 in conjunction with the second passage 125 (the vent). Since the embodiment from which the fourth frequency response curve 340 is taken has not implemented a second passage 125 (a vent), correspondingly this acoustic resonance peak lacks.

The first frequency range 301 covers a resonance peak being present in both the third frequency response curve 330 and the fourth frequency response curve 340. This resonance peak is the main transducer resonance peak and is substantially in the same frequency range in comparison to the frequency response curves plotted in FIG. 3a. A comparison of the third frequency response curve 330 and the fourth frequency response curve 340 shows that the presence of a second passage 125 (a vent) shifts the frequencies of the main transducer resonance peak to higher frequency values. It can be seen, that a suitable adapted second passage 125 is essential for a proper and efficient low frequency acoustic amplification.

The first frequency range 302 covers a further resonance peak being present in both the third frequency response curve 330 and the fourth frequency response curve 340 and being substantially congruent. This resonance peak is based on the acoustic properties of the first cavity 110 in conjunction with the acoustic properties of the first passage 125 or the slit having a predefined cross-sectional area, respectively. The resonance properties of this first cavity resonance peak is not influenced by the second passage 125 (or the vent, respectively) since the second passage 125 and the second cavity 120 are designed and dimensioned such that the combination of both is only acoustically active in a low acoustic frequency section. This first cavity resonance peak is substantially in the same frenquency range in comparison to the frequency response curves plotted in FIG. 3a.

The first frequency range 303 covers a further resonance peak being present in both the third frequency response curve 330 and the fourth frequency response curve 340 and being substantially congruent. This resonance peak is based on the acoustic properties of the third cavity 130 in conjunction with the acoustic properties of the outlets 150 as well as the influence of the dust shielding 140. The influence of the presents of the second passage is slightly small. This third cavity resonance peak is substantially in the same frequency range in comparison to the frequency response curves plotted in FIG. 3a.

Conclusively, three supplementary acoustic resonance areas are present in the frequency response curve of a sound generating device according to an embodiment of the invention. A low frequency resonance amplifies and extends the frequency response of the transducer to lower frequencies. This low frequency resonance results from the second cavity 120 in combination with the second passage 125 and from the being phase adaptation emerging from a suitable design of the second passage 125. A first cavity acoustic resonance resulting from the acoustic properties of the first cavity 110 in combination with the first passage 115 and a third cavity acoustic resonance resulting from the acoustic properties of the third cavity 130 in combination with the outlets 150 extends the frequency response of the transducer to higher frequencies, wherein the third cavity acoustic resonance (at frequencies about 3 kHz) is above the first cavity acoustic resonance (at frequencies about 6.5 kHz).

FIG. 4 shows a mobile electric device having implemented a sound generating apparatus according to an embodiment of the invention. Sound outputting components (FIG. 4 illustrates several outlets 150 of such an sound outputting components) according to an embodiment of the sound generating apparatus with respect to the invention are advantageously suitable and applicable in all deices requiring a sound outputting device and particular in devices of limited size such as portable and mobile electric device 200. A broard number of possible portable and mobile electric devices 200 implements sound outputting components, especially multi-media enabled devices require sound outputting components emitting sound of enhanced quality.

For example notebooks, personal digital assistants (PDA), Palmtops which are examples of portable processing devices having limited housing dimensions are suitable for implementing such a sound generating apparatus. Further, sound reproducing devices like mobile CD-payers, mobile MP3-players, and further mobile products of the HIFI industry are also capable to implement.

Particularly, cellular phones are suitable target for implementation. Cellular phones of the current generation implement more and more multi-media features, like electronic music players (MP3 players, AAC players, or related standards), electronic video players (MPEG players or related standards) and also polyphonic alarm tones (ringing tones). All these features will be improved in their use in case of an implemented sound generating component of enhanced quality since not all users wish to carry headphones or it is desired to reproduce sound audible simultaneously by a group of users e.g. in a hand-free operation mode.

But also in view of coming standards offering high data rates the number and the usage of music and video streaming applications will rise. Besides the optical reproducing quality which can be achieved yet with available displays the reproducing quality of sound is today of minor quality such that headphones are the only solution up to now. The sound generating apparatus, components or systems according to an embodiment of the present invention overcome the minor sound reproducing quality which will also be a quality enhancement in conjunction with a simple phone call, i.e. the reproduction of voices and transmitted speech will be also improved.

The electric device having implemented a sound generating apparatus according to an embodiment of the invention may partially dictated dimensioning of the implemented sound generating apparatus. Especially the mostly limited housing of the electric device defines the outer dimensions of the sound generating apparatus, wherein a part of the housing of the electric device may act simultaneously as one or more parts of one or more of the several cavities and further acoustic components of the sound generating apparatus. Correspondingly, the dimensioning of the cavities and their connecting passages have to be adapted to the outer housing of the electric device, wherein the dimensioning of the connecting passages has to be adapted to the volume of the cavities and the desired acoustic resonance amplifications.

The invention, as described in this embodiment provides acoustical amplification within mainly two different frequency regions, namely in the frequency range between 300 and 400 Hz, and in the range of 3 kHz to 7 kHz. The amplification in the lower frequency range serves to have the frequency spectrum extended to the low frequency area for improving the reproduction of music for example. The amplification in the higher frequency range is especially important for the reproduction of ringing tone and alert tone signals in mobile communication terminals, because frequencies in this range are better heard and thereby draw a users attention to an incoming call or message.

In order to have a more flat frequency spectrum for the reproduction of music it can be advantageous to attenuate the frequencies in the range of 3 kHz and 7 kHz for this embodiment electronically before giving the signal to the transducer of the system. A digital signal processor (DSP) allows for adopting frequencies and frequency curves of an electric signal to be supplied to the transducer to the acoustic frequency characteristics of the overall sound generating device/system resulting in a suitable flattened acoustic response signal suitable for reproducing music.

It will be obvious for those skilled in the art that as the technology advances, the inventive concept can be implemented in a different and broader number of ways. The invention and its embodiments are thus not limited to the examples described above but may vary within the scope of the claims.

### List of Reference Numerals

100: transducer
105: transducer signal
110: first cavity (front cavity)
115: first passage (slit)
120: second cavity (back cavity)
125: second passage (vent)
130: third cavity (mixing cavity)
140: shielding
150: outlets
160: radiating acoustic waves
170: enclosure outline
180: acoustic coupling path
185: main direction
190: supplementary direction
200: mobile electric device
300: first frequency range
301: second frequency range
302: third frequency range
303: fourth frequency range
310: first frequency response curve
20: second frequency response curve
30: third frequency response curve
40: fourth frequency response curve

1. Sound generating apparatus comprising:
a first cavity (110);
a second cavity (120); and
an electromechanical transducer (100),
said electromechanical transducer (100) for exciting sound waves in said first cavity (110) and said second cavity (120);
a third cavity (130), wherein said third cavity (130) is connected to said first cavity (110) via at least one first passage (115) of predefined shape, and said third cavity (130) is connected to said second cavity (120) via at least one second passage (125) of predefined shape,
said third cavity (130) having one or more outlets (150) allowing sound waves to radiate (160) into an exterior of said apparatus;
wherein said sound generating apparatus provides for acoustical amplification in a low frequency range,
wherein said sound generating apparatus also provides for acoustical amplification in a high frequency range, wherein said high frequency range amplification is in a frequency range between 850 Hz and 7 kHz.

2. Apparatus according to claim 1, wherein said high frequency range amplification serves for acoustical amplification in a frequency range between 950 Hz and 7 kHz.

3. Apparatus according to claim 2, wherein said high frequency range amplification serves for acoustical amplification in a frequency range between 2 kHz and 7 kHz.

4. Apparatus according to claim 1, wherein said high frequency range includes at least one acoustic resonance, which serves for acoustic amplification.

5. Apparatus according to claim 1, wherein said sound generating apparatus is adapted to a perceptible frequency range of human organs of hearing, which ranges approximately from 20 Hz to 18 kHz.

6. Apparatus according to claim 1, wherein said electromechanical transducer (100) has a main direction (185) for emitting sound and a supplementary direction (190) for emitting sound, wherein sound waves emitted along said main direction (185) are radiated into said first cavity (110) and sound waves emitted along said supplementary direction (190) are radiated into said second cavity (120).

7. Apparatus according to claim 1, wherein said first cavity (110) has a first volume and said second cavity (120) has an essentially bigger second volume.

8. Apparatus according to claim 1, wherein said first cavity (110) and said third cavity (130) have substantially an approximately same volume.

9. Apparatus according to claim 1, wherein said first cavity (110) and said second cavity (120) are arranged adjacent to each other, wherein said first cavity (110) and said second cavity (120) are spatially separated from each other by said electromechanical transducer (100).

10. Apparatus according to claim 1, wherein said electromechanical transducer (100) is a loudspeaker.

11. Apparatus according to claim 1, wherein said apparatus is suitable for being implemented in a portable electric device (200).

12. Mobile electric device comprising a sound generating apparatus comprising:
a first cavity (110);
a second cavity (120); and
an electromechanical transducer (100),
said electromechanical transducer (100) for exciting sound waves in said first cavity (110) and said second cavity (120);
a third cavity (130), wherein said third cavity (130) is connected to said first cavity (110) via at least one first passage (115) of predefined shape, and said third cavity (130) is connected to said second cavity (120) via at least one second passage (125) of predefined shape,
said third cavity (130) having one or more outlets (150) allowing to radiate sound waves (160) into the exterior;
wherein said sound generating apparatus provides for acoustical amplification in a low frequency range,
wherein said sound generating apparatus also provides for acoustical amplification in a high frequency range, and wherein said high frequency range amplification is located in a frequency range between 850 Hz and 7 kHz.

13. System for generating sound comprising:
a first cavity (110);
a second cavity (120); and
an electromechanical transducer (100),
said electromechanical transducer (100) for exciting sound waves in said first cavity (110) and said second cavity (120);
a third cavity (130), wherein said third cavity (130) is connected to said first cavity (110) via at least one first passage (115) of predefined shape, and said third cavity (130) is connected to said second cavity (120) via at least one second passage (125) of predefined shape,
said third cavity (130) having one or more outlets (150) allowing to radiate sound waves to radiate (160) into an exterior of said system;
wherein said system for generating sound provides for acoustical amplification in a low frequency range,
wherein said system for generating sound generating provides also for acoustical amplification in a high frequency range, and wherein said high frequency range amplification is located in a frequency range between 850 Hz and 7 kHz.
